(19) United States
(12) Patent Application Publication
(10) Pub. No.: US 2025/0376117 A1
(43) Pub. Date: Dec. 11, 2025

(54) VEHICLE VISUAL RECOGNITION DEVICE

(71) Applicant: KABUSHIKI KAISHA TOKAI-RIKA-DENKI-SEISAKUSHO, Aichi-ken (JP)

(72) Inventor: Yuto NAKAYAMA, Aichi (JP)

(21) Appl. No.: 19/226,662

(22) Filed: Jun. 3, 2025

(30) Foreign Application Priority Data
Jun. 7, 2024 (JP) 2024-093207

(51) Int. Cl. B60R 1/06

(52) U.S. Cl. CPC B60R 1/06

(57) ABSTRACT

A vehicle visual recognition device includes: a cover part having an opening portion; a lens part having a distal end portion disposed at the opening portion, with a predetermined gap maintained from an inner peripheral surface of the opening portion; a rear wall portion standing on an outer peripheral side and a back surface side of the opening portion in the cover part; and a protruding portion that is interposed between the rear wall portion and the lens part, and that has a position of contact with one of the rear wall portion or the lens part on the outer peripheral side of the opening portion.

### CROSS-REFERENCE TO RELATED APPLICATION

This application is based on and claims priority under 35 USC 119 from Japanese Patent Application No. 2024-093207 filed on Jun. 7, 2024, the disclosure of which is incorporated by reference herein.

### BACKGROUND

### Technical Field

The present disclosure relates to a vehicle visual recognition device.

### Related Art

Japanese Patent Application Laid-Open (JP-A) No. 2007-308074 discloses a mode in which a gap is formed between a cover part and a lamp part in an outer mirror including the cover part having an opening portion and the lamp part disposed in the opening portion.

However, in the outer mirror disclosed in JP-A No. 2007-308074, the lamp part is fixed to the housing body via a lamp cover, and the cover part is then attached to the housing body. Since the housing body, the lamp cover, and the like are involved in the positioning of the cover part and the lamp part, it is difficult to control the gap between the cover part and the lamp part, and there is room for improvement in terms of positioning accuracy. Furthermore, the inside of the cover part is visible through the gap, and there is room for improvement in terms of appearance.

### SUMMARY

The present disclosure provides a vehicle visual recognition device capable of increasing positioning accuracy and reducing degradation in appearance.

A vehicle visual recognition device according to a first aspect of the present disclosure includes: a cover part having an opening portion; a lens part having a distal end portion disposed at the opening portion, with a predetermined gap maintained from an inner peripheral surface of the opening portion; a rear wall portion standing on an outer peripheral side and a back surface side of the opening portion in the cover part; and a protruding portion that is interposed between the rear wall portion and the lens part, and that has a position of contact with the rear wall portion or the lens part on the outer peripheral side of the opening portion.

In the vehicle visual recognition device according to the first aspect of the present disclosure, the projecting portion is interposed between the lens part and the rear wall portion standing on the outer peripheral side of the opening portion in the cover part and on the back surface side, and the position of contact of the protruding portion with the rear wall portion or the lens part is set on the outer peripheral side of the opening portion in the cover part. Accordingly, direct positioning between the lens part and the rear wall portion can be performed with the protruding portion, and thus, positioning accuracy can be increased. Furthermore, the protruding portion is interposed between the lens part and the rear wall portion standing on the outer peripheral side of the opening portion and on the back surface side, and the position of contact of the protruding portion with the rear wall portion or the lens part is set on the outer peripheral side of the opening portion. Accordingly, the protruding portion is provided at a position one step behind the opening portion. Thus, it is possible to make it difficult to see the inside of the cover part through the gap, and it is possible to reduce degradation in appearance.

A vehicle visual recognition device according to a second aspect of the present disclosure is the vehicle visual recognition device according to the first aspect, in which the protruding portion is provided at a position shifted from at least one of a first straight line or a second straight line, the first straight line connecting a first corner portion of an end of the distal end portion of the lens part and a second corner portion of a main body portion provided in the lens part and in contact with the protruding portion, and the second straight line connecting the first corner portion and a third corner portion of an inner peripheral rear end of the opening portion, in a longitudinal sectional view of a mounted state.

In the vehicle visual recognition device according to the second aspect of the present disclosure, the protruding portion is provided at a position shifted from at least one of the first straight line or the second straight line. Thus, the protruding portion can be provided at a position shifted from the line of sight when the first straight line and the second straight line are substantially the same lines as the line of sight.

A vehicle visual recognition device according to a third aspect of the present disclosure is the vehicle visual recognition device according to the second aspect, in which a shoulder portion that has a wider portion in a vehicle vertical direction and faces the rear wall portion is formed at the main body portion, and a sealing member is disposed at the shoulder portion so as to extend from an end surface of the rear wall portion on the side of the lens part.

In the vehicle visual recognition device according to the third aspect of the present disclosure, the sealing member is disposed at the shoulder portion facing the rear wall portion so as to extend from the end surface of the rear wall portion on the side of the lens part. Thus, it is possible to make it difficult to see the sealing member through the gap between the lens part and the cover part.

A vehicle visual recognition device according to a fourth aspect of the present disclosure is the vehicle visual recognition device according to any one of the first to third aspects, in which the protruding portion is provided at the rear wall portion.

In the vehicle visual recognition device according to the fourth aspect of the present disclosure, the protruding portion is provided at the rear wall portion. Accordingly, the protruding portion provided at the rear wall portion and the lens part abut on each other, and thus, positioning can be performed between the lens part and the rear wall portion.

A vehicle visual recognition device according to a fifth aspect of the present disclosure is the vehicle visual recognition device according to any one of the first to third aspects, in which the protruding portion is provided at the lens part.

In the vehicle visual recognition device according to the fifth aspect of the present disclosure, the protruding portion is provided on the lens part. Accordingly, the protruding portion provided on the lens part and the rear wall portion abut on each other, and thus, positioning can be performed between the lens part and the rear wall portion.

A vehicle visual recognition device according to a sixth aspect of the present disclosure is the vehicle visual recognition device according to any one of the first to fifth aspects, in which the protruding portion is provided at each of the surfaces facing each other in the vehicle vertical direction.

In the vehicle visual recognition device according to the sixth aspect of the present disclosure, the protruding portion is provided at each of the surfaces facing each other in the vehicle vertical direction, and thus, positioning in the vehicle vertical direction can be performed with the protruding portion.

A vehicle visual recognition device according to a seventh aspect of the present disclosure is the vehicle visual recognition device according to any one of the first to sixth aspects, in which the protruding portion is provided at at least one of the surfaces facing each other in the vehicle width direction.

In the vehicle visual recognition device according to the seventh aspect of the present disclosure, the protruding portion is provided at at least one of the surfaces facing each other in the vehicle width direction, and thus, positioning in the vehicle width direction can be performed with the protruding portion.

A vehicle visual recognition device according to an eighth aspect of the present disclosure is the vehicle visual recognition device according to any one of the first to seventh aspects, in which protruding portions are arranged in a continuous manner or at intervals.

In the vehicle visual recognition device according to the eighth aspect of the present disclosure, in a case where the protruding portions are arranged in a continuous manner, the contact areas between the protruding portions and the lens part or the rear wall portion can be made larger than those in a case where the protruding portions are arranged at intervals. Thus, positioning can be performed more firmly. In a case where the protruding portions are arranged at intervals, on the other hand, the contact areas between the protruding portions and the lens part or the rear wall portion can be set in conformity with the shape or the like. As a result, the contact areas between the protruding portions and the lens part or the rear wall portion can be further reduced compared with those in the case where the protruding portions are arranged in a continuous manner, and thus, squeaking noise can be reduced.

A vehicle visual recognition device according to a ninth aspect of the present disclosure is the vehicle visual recognition device according to any one of the first to eighth aspects, in which plural protruding portions is included, and the plural protruding portions is provided to face each other in a direction in which the opening portion is interposed between the protruding portions.

In the vehicle visual recognition device according to the ninth aspect of the present embodiment, plural protruding portions is provided so as to face each other in the direction in which the opening portion is interposed between the protruding portions. Thus, the gap can be positioned from both sides between which the opening portion is interposed.

A vehicle visual recognition device according to a tenth aspect of the present disclosure is the vehicle visual recognition device according to any one of the first to ninth aspects, in which a wall portion abutting on the rear end of the lens part from the vehicle front side is provided on the rear aide of the lens part.

In the vehicle visual recognition device according to the tenth aspect of the present disclosure, the wall portion abutting on the rear end of the lens part from the vehicle front side is provided on the rear side of the lens part. Thus, positioning in the vehicle longitudinal direction can be performed with the wall portion.

As described above, a vehicle visual recognition device according to the present disclosure has an effect to increase positioning accuracy and an effect to reduce degradation in appearance.

### BRIEF DESCRIPTION OF THE DRAWINGS

Exemplary embodiments of the present disclosure will be described in detail based on the following figures, wherein:

FIG. 1 is a perspective view of a door mirror device according to an embodiment of the present disclosure, as viewed from the inside in the vehicle width direction;

FIG. 2 is a perspective view of the relevant portion of the door mirror device shown in FIG. 1, as viewed from the vehicle front side and the outside in the vehicle width direction;

FIG. 3 is a cross-sectional view of the relevant portion of a cross section taken along the line III-III defined in FIG. 2, as viewed from the outside in the vehicle width direction;

FIG. 4 is a perspective view of the relevant portion of the door mirror device shown in FIG. 2, as viewed from the vehicle front side;

FIG. 5 is a cross-sectional view of the relevant portion of a cross section taken along the line V-V defined in FIG. 4, as viewed from the upper side of the vehicle;

FIG. 6 is a schematic rear view of a visor cover as viewed from the vehicle rear side;

FIG. 7 is an enlarged view of the relevant portion shown in FIG. 6;

FIG. 8 is a diagram schematically illustrating a positioning contact region between the visor cover and a turn lamp;

FIG. 9 is an enlarged view of the vehicle rear side of the turn lamp as viewed from the vehicle left side;

FIG. 10 is a cross-sectional view of a cross section taken along the line X-X defined in FIG. 9, as viewed from the upper side of the vehicle;

FIG. 11 is a cross-sectional view of the relevant portion of a cross section taken along the line III-III in another door mirror device corresponding to FIG. 2, as viewed from the outside in the vehicle width direction;

FIG. 12 is a cross-sectional view of the relevant portion of a cross section taken along the line III-III in yet another door mirror device corresponding to FIG. 2, as viewed from the outside in the vehicle width direction;

FIG. 13 is a diagram schematically illustrating another mode of the positioning contact region between the visor cover and the turn lamp; and

FIG. 14 is a schematic rear view of another visor cover as viewed from the vehicle rear side.

### DETAILED DESCRIPTION

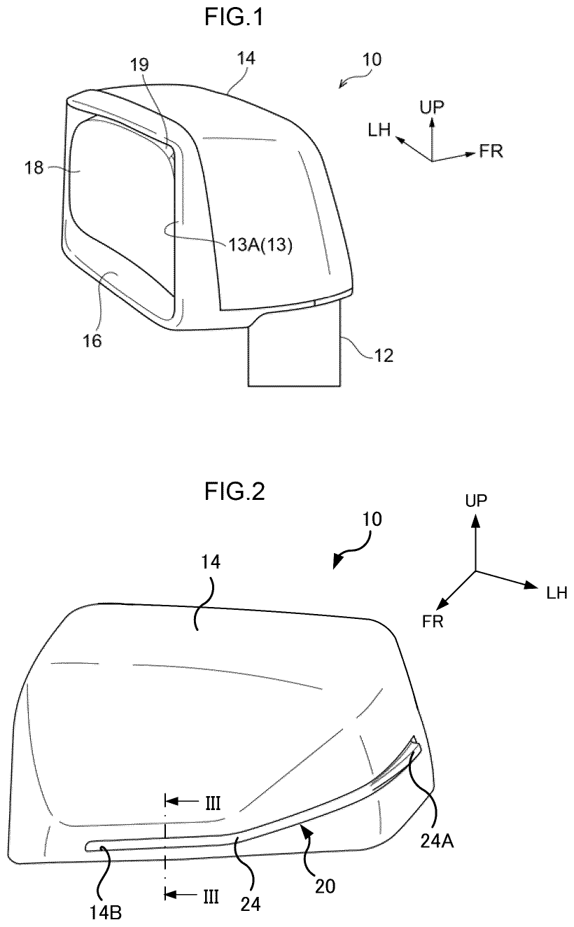

A door mirror device 10 as a vehicle visual recognition device according to an embodiment of the present disclosure is described with reference to FIGS. 1 to 10. As an example, the door mirror device 10 of the present embodiment is installed at a vehicle-front-side end of a vertically intermediate portion of a side door (a front side door (not shown)) of a vehicle (automobile), and is disposed on the outer side of the side door of the vehicle.

FIG. 1 is a perspective view of the door mirror device 10 as a vehicle visual recognition device according to an embodiment of the present disclosure, as viewed from the inside in the vehicle width direction. FIG. 2 is a perspective view of the door mirror device 10 shown in FIG. 1, as viewed from the vehicle front side and the outside in the vehicle width direction. Note that, in the drawings, the front side of the vehicle is indicated by an arrow FR, the left side in the vehicle width direction (the outer side in the vehicle width direction) is indicated by an arrow LH, and the upper side is indicated by an arrow UP.

In the present embodiment, the door mirror device 10 disposed on the left side in the vehicle width direction is described below, but the present disclosure can also be applied to a door mirror device disposed on the right side in the vehicle width direction, for example.

As shown in FIG. 1, the door mirror device 10 has a substantially columnar stay 12 as the support, and a lower portion of the stay 12 is fixed to a side door (not shown), so that the door mirror device 10 is attached to the side door.

On the upper side of the stay 12, a vehicle-width-direction inner portion of a visor cover 14 having a substantially rectangular-parallelepiped-box-like shape as a peripheral member (a cover part) is supported. When the door mirror device 10 is in use, which is a time when the door mirror device 10 is in an open state, the visor cover 14 protrudes outward in the vehicle width direction with respect to the stay 12. The visor cover 14 has a substantially rectangular opening 16 on the vehicle rear side surface, and, through the opening 16, the inside of the visor cover 14 is open to the vehicle rear side.

On the outer side of the opening 16 of the visor cover 14, a visor rim 13 having a peripheral portion 13A (a canopy) is provided in the entire circumferential direction of the opening 16. A mirror 18 having a substantially rectangular-plate-like shape is disposed in the peripheral portion 13A of the visor cover 14, the front side of the mirror 18 is exposed to the rear side of the vehicle through the opening 16 of the visor cover 14, and an occupant of the vehicle views the reflected light of the mirror 18 from the inner side of the mirror 18 in the vehicle width direction. In this manner, the occupant's visual recognition of the rear side of the vehicle is aided.

The rear side and the outer periphery of the mirror 18 are covered with a mirror holder 19 as a covering member, and the rear side surface of the mirror 18 is fixed to the mirror holder 19 with double-sided tape (not shown), for example.

Also, as illustrated as an example in FIG. 2, the visor cover 14 has an opening portion 14B formed with a long substantially rectangular hole extending from the vehicle front side wall along the outer sidewall in the vehicle width direction. Through the opening portion 14B, the inside of the visor cover 14 is open on the vehicle front side and on the outer side in the vehicle width direction, and the outer end of the opening portion 14B in the vehicle width direction is located on the vehicle rear side.

In the visor cover 14, a turn lamp 20 as a lens part is provided. The turn lamp 20 has an elongated shape along the shape of the opening portion 14B, and is fixed to the back surface of the visor cover 14 by a later-described housing 30 provided inside the visor cover 14.

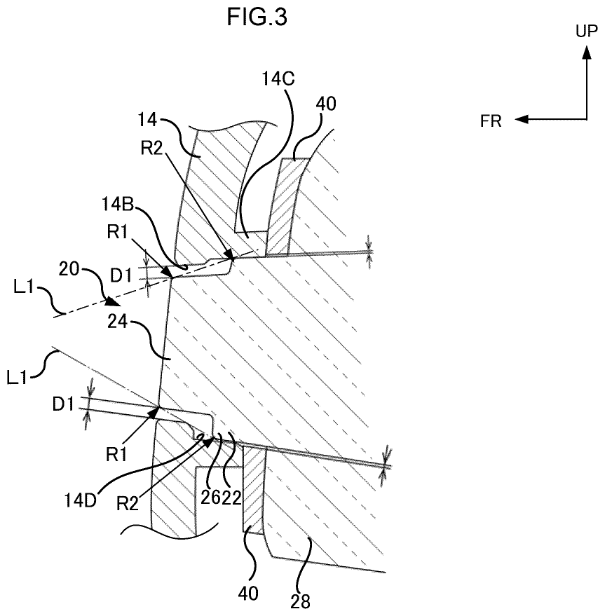

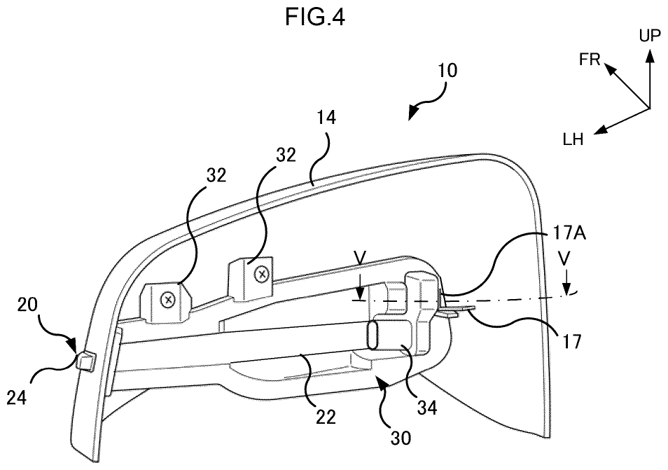

FIG. 3 is a longitudinal sectional view of the relevant portion taken along the line III-III defined in FIG. 2, as viewed from the outside in the vehicle width direction. FIG. 4 is a perspective view of the relevant portion of the door mirror device 10 shown in FIG. 2, as viewed from the rear side of the vehicle. As shown in FIG. 3, the turn lamp 20 includes a main body portion 22 supported by the later-described housing 30, and a distal end portion 24 that is disposed on the vehicle front side of the main body portion 22, has a smaller outer shape than that of the main body portion 22, and is formed integrally with the main body portion 22.

The main body portion 22 is widened in the vehicle vertical direction and the vehicle width direction from the distal end portion 24, and a shoulder portion 26 is formed at the end on the side of the distal end portion 24 of the main body portion 22, which is a boundary portion between the main body portion 22 and the distal end portion 24. Also, the main body portion 22 is further widened in the vehicle vertical direction and the vehicle width direction from the shoulder portion 26 on the vehicle rear side of the shoulder portion 26, and a second shoulder portion 28 is formed at a boundary portion on the boundary with the shoulder portion 26. The second shoulder portion 28 corresponds to a shoulder portion, and faces a rear wall portion 14C in the vehicle longitudinal direction. In the present embodiment, a sealing member 40 is disposed between the rear wall portion 14C and the second shoulder portion 28. The sealing member 40 is disposed along the front surface side of the second shoulder portion 28 from the end surface of the rear wall portion 14C on the side of the main body portion 22.

As illustrated in FIG. 4, the main body portion 22 is fixed to the back surface of the visor cover 14 by the housing 30. Specifically, the housing 30 is formed in an elongated shape curved along the main body portion 22, and has two brackets 32 as an example on the vehicle upper side. The main body portion 22, which is the turn lamp 20, is fixed to the back surface of the visor cover 14 by the brackets 32.

On the right side (inner side) of the housing 30 in the vehicle width direction, a case 34 or the like in which a connector (not shown) or the like for electrically connecting a circuit board (not shown) for controlling an LED (not shown) for blinking light and a control device (not shown) of the vehicle are accommodated is provided. Further, a rib 17 for positioning the housing 30 in the vehicle longitudinal direction is provided on the inner side in the vehicle width direction of the back surface of the visor cover 14.

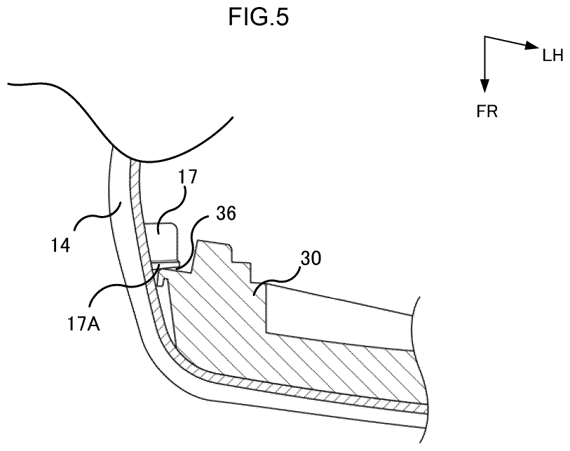

FIG. 5 is a cross-sectional view of the relevant portion of the cross section taken along the line V-V defined in FIG. 4, as viewed from the upper side of the vehicle. As illustrated in FIG. 5, the rib 17 protrudes from the back surface of the visor cover 14 toward the left side (outer side) in the vehicle width direction, and includes a wall portion 17A extending upward on the vehicle front side. A rear end 36 of the housing 30 on the vehicle rear side on the right side (outer side) in the vehicle width direction abuts on the wall portion 17A from the vehicle front side, so that the turn lamp 20 is positioned in the vehicle longitudinal direction.

Referring back to FIG. 3, as an example, the distal end portion 24 is disposed in the opening portion 14B, with a predetermined gap D1 maintained with respect to the inner peripheral surface of the opening portion 14B. Here, the predetermined gap D1 means a gap having a dimension determined in advance by regulations or the like. The distal end portion 24 has an elongated shape curved in conformity with the shape of the opening portion 14B, is formed with a light transmissive member, and is exposed to the outside of the visor cover 14 through the opening portion 14B of the visor cover 14. In the present embodiment, as illustrated in FIG. 2 as an example, the distal end portion 24 has a convex portion 24A that gradually protrudes from the opening portion 14B toward the rear on the outer side in the vehicle width direction and at a rear end portion on the vehicle rear side.

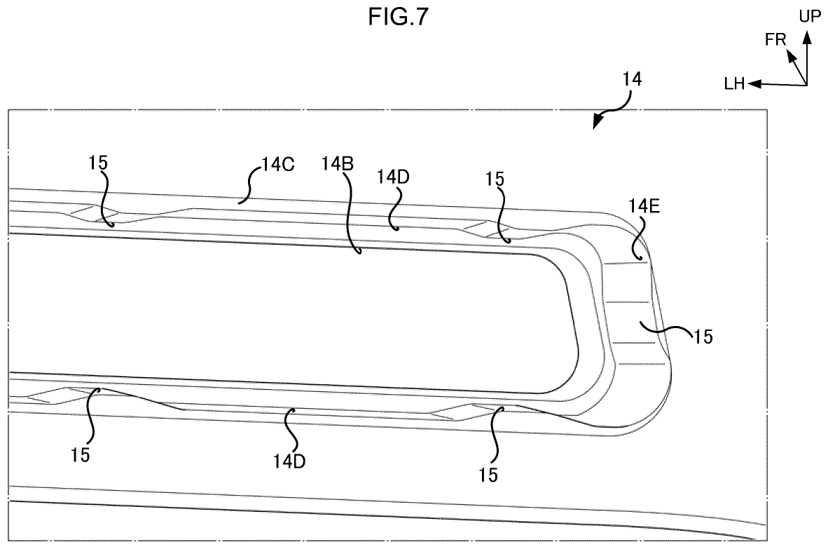

Further, as illustrated in FIG. 3, the visor cover 14 includes the rear wall portion 14C that stands on the outer peripheral side of the opening portion 14B and on the back surface side (vehicle rear side). That is, on the back surface side of the visor cover 14, the rear wall portion 14C stands to the rear side of the vehicle so as to surround the opening portion 14B on the outer peripheral side of the opening portion 14B. The rear wall portion 14C is formed integrally with the visor cover 14, and the rear wall portion 14C and the shoulder portion 26 face each other. Protruding portions 15 (see FIG. 7) to be described later are interposed between the rear wall portion 14C and the shoulder portion 26.

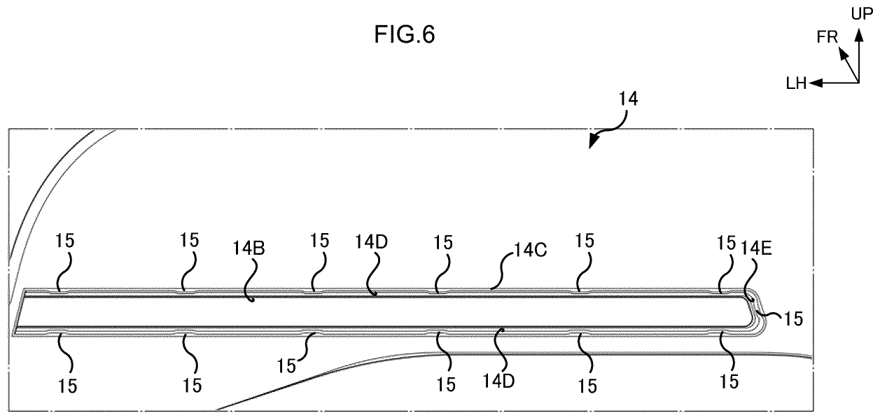

In the present embodiment, as an example, the protruding portions 15 are provided on the rear wall portion 14C. FIG. 6 is a schematic rear view of the visor cover 14 as viewed from the rear side of the vehicle. FIG. 7 is an enlarged view of the relevant portion shown in FIG. 6. As illustrated in FIGS. 6 and 7, the protruding portions 15 are provided on the respective surfaces 14D of the rear wall portion 14C facing each other in the vehicle vertical direction via the turn lamp 20. The protruding portions 15 are also provided on an inner side surface 14E on the inner side in the vehicle width direction of the rear wall portion 14C via the turn lamp 20.

As illustrated in FIGS. 3 and 7, in the present embodiment, the protruding portions 15 are provided at positions one step behind the inner surface of the opening portion 14B on the outer peripheral side of the opening portion 14B, on the back surface side of the visor cover 14, which is the rear side of the vehicle. Specifically, as illustrated in FIG. 3, the protruding portions 15 are provided at positions shifted from first straight lines L1 connecting first corner portions R1 of the distal end of the distal end portion 24 on the vehicle upper side and the vehicle lower side, and second corner portions R2 of the shoulder portion 26 of the main body portion 22, in a longitudinal sectional view in which the turn lamp 20 is in a mounted state.

Also, in the present embodiment, as an example, plural protruding portions 15 is arranged at intervals on the surfaces 14D, and the protruding portions 15 provided on the surfaces 14D are positioned to face each other in such a direction that the opening portion 14B is interposed. Specifically, as an example, the visor cover 14 has six protruding portions 15 on the surfaces 14D on the vehicle upper side and the surfaces 14D on the vehicle lower side, and has a total of seven protruding portions, with the protruding portion 15 on the inner side surface 14E added thereto.

As illustrated in FIG. 7, the protruding portions 15 protrude from the surfaces 14D and the inner side surface 14E toward the opening portion 14B, and, as an example, have a tapered shape from each of the surfaces 14D and 14E toward the opening portion 14B, and the ends thereof are formed in a substantially flat shape.

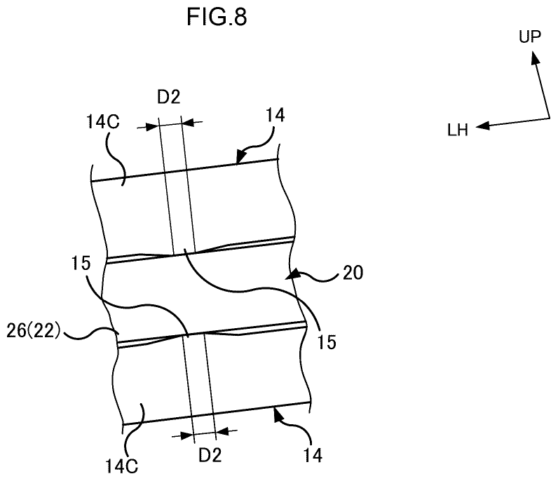

FIG. 8 is a diagram schematically illustrating a positioning contact region between the visor cover 14 and the turn lamp 20. As illustrated in FIG. 8, the flat surfaces of the ends of the protruding portions 15 formed on the rear wall portion 14C abut on the shoulder portion 26 of the main body portion 22. In the present embodiment, the protruding portions 15 are provided to face each other in such a direction that the opening portion 14B (see FIG. 7) is interposed, and accordingly, the main body portion 22 abuts on the protruding portions 15 from both sides in the vehicle vertical direction. Specifically, in the region of a dimension D2 in the vehicle width direction of the flat surfaces of the ends of the protruding portions 15, the main body portion 22, which is the turn lamp 20, is brought into contact with the flat surfaces, and thus, is positioned in the vehicle vertical direction. Positioning in the vehicle vertical direction is performed at the respective positions of the protruding portions 15 facing each other in the direction in which the opening portion 14B is interposed.

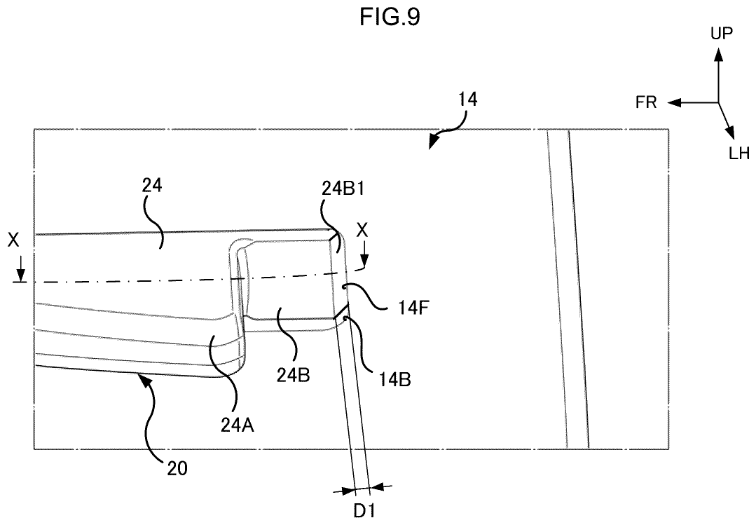

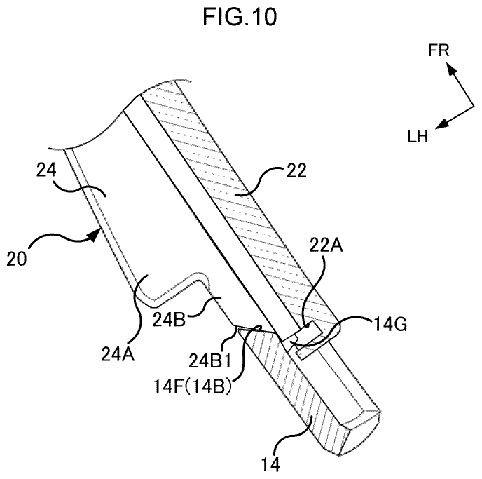

FIG. 9 is an enlarged view of the vehicle rear side of the turn lamp 20 as viewed from the vehicle left side. FIG. 10 is a cross-sectional view of the cross section taken along the line X-X defined in FIG. 9, as viewed from the vehicle upper side. As illustrated in FIG. 9, the convex portion 24A described above is formed so that the end portion on the vehicle rear side is substantially orthogonal to the visor cover 14, and a rear end portion 24B extending from the convex portion 24A is provided further on the vehicle rear side of the convex portion 24A. In the present embodiment, as an example, the rear end portion 24B of the turn lamp 20 has an inclination with which a rear end surface 24B1 on the vehicle rear side is wider on the vehicle rear side at a position closer to the inner side (right side) in the vehicle width direction.

Further, as shown in FIG. 10, an inner surface 14F of the opening portion 14B on the vehicle rear side has an inclination with which the opening of the opening portion 14B is wider at a position closer to the inside (right side) in the vehicle width direction, so as to match the inclination of the rear end surface 24B1. As illustrated in FIG. 9, on the front surface side of the visor cover 14, the predetermined gap D1 is provided between the rear end surface 24B1 of the rear end portion 24B and the inner surface 14F of the inner surface of the opening portion 14B on the vehicle rear side.

Also, as illustrated in FIG. 10, on the back surface side of the visor cover 14, which is the inner side (right side) in the vehicle width direction, a projecting portion 14G protruding toward the inner side (right side) in the vehicle width direction is provided on the outer peripheral side (vehicle rear side) of the inner surface 14F of the visor cover 14.

The main body portion 22 of the turn lamp 20 has a recessed portion 22A engaged with the projecting portion 14G at the position corresponding to the projecting portion 14G. The recessed portion 22A is cut out in a substantially rectangular parallelepiped shape from the outer side (left side) toward the inner side (right side) in the vehicle width direction. In the present embodiment, the projecting portion 14G abuts on the inner surface of the recessed portion 22A on the vehicle front side.

Further, in the longitudinal direction of the turn lamp 20, the end portion on the inner side (right side) in the vehicle width direction abuts on the protruding portions 15, and the end portion on the outer side (left side) in the vehicle width direction and on the vehicle rear side abuts on the projecting portion 14G, so that the turn lamp 20 is positioned with respect to the visor cover 14 in the longitudinal direction.

Next, functions and effects of the present embodiment are described.

The door mirror device 10 of the present embodiment includes the protruding portions 15 interposed between the rear wall portion 14C standing on the outer peripheral side of the opening portion 14B and on the back surface side in the visor cover 14, and the main body portion 22 of the turn lamp 20. Accordingly, positioning can be performed directly between the turn lamp 20 and the rear wall portion 14C with the protruding portions 15, and thus, positioning accuracy can be increased. Also, the protruding portions 15 are interposed between the main body portion 22 and the rear wall portion 14C standing on the outer peripheral side of the opening portion 14B and on the back surface side, and thus, the protruding portions 15 are disposed at positions one step behind the opening portion 14B. Thus, it is possible to make it difficult to see the inside of the visor cover 14 through the gap between the distal end portion 24 of the turn lamp 20 and the visor cover 14, and it is possible to prevent gradation in appearance.

Further, in the door mirror device 10 of the present embodiment, the protruding portions 15 are provided at positions shifted from the first straight lines L1 connecting the first corner portions R1 of the distal end of the distal end portion 24 on the vehicle upper side and the vehicle lower side, and the second corner portions R2 of the shoulder portion 26 of the main body portion 22, in a longitudinal sectional view in which the turn lamp 20 is in a mounted state. Thus, when the first straight lines L1 are lines substantially equal to the line of sight, the protruding portions 15 can be provided at positions not on the line of sight.

Further, in the door mirror device 10 of the present embodiment, the sealing member 40 is disposed on the second shoulder portion 28 facing the rear wall portion 14C so as to extend from the end surface of the rear wall portion 14C on the side of the turn lamp 20, and thus, the sealing member 40 can be made less visible through the gap between the distal end portion 24 and the visor cover 14. Furthermore, by disposing the sealing member 40 so as to extend from the end surface of the rear wall portion 14C on the side of the turn lamp 20, it is possible to shorten the attachment region of the sealing member 40 in the vehicle vertical direction, and thus, the turn lamp 20 can be made smaller in size.

Also, in the door mirror device 10 of the present embodiment, the protruding portions 15 are provided on the rear wall portion 14C. Thus, the protruding portions 15 provided on the rear wall portion 14C abut on the main body portion 22 of the turn lamp 20, so that positioning can be performed between the main body portion 22 and the rear wall portion 14C.

Further, in the door mirror device 10 of the present embodiment, the protruding portions 15 are provided on each of the surfaces 14D facing each other in the vehicle vertical direction, and thus, positioning in the vehicle vertical direction can be performed with the protruding portions 15.

Also, in the door mirror device 10 of the present embodiment, the protruding portion 15 is provided on the inner side surface 14E that is one of the surfaces facing each other in the vehicle width direction, and thus, positioning in the vehicle width direction can be performed with the protruding portion 15.

Further, in the door mirror device 10 of the present embodiment, the protruding portions 15 are arranged at intervals, and thus, the contact portions between the protruding portions 15 and the turn lamp 20 can be set in conformity with the shape or the like. As a result, the contact areas between the protruding portions 15 and the turn lamp 20 can be further reduced as compared with those in the case where the protruding portions 15 are arranged in a continuous manner, and thus, squeaking noise can be reduced.

Also, in the door mirror device 10 of the present embodiment, the protruding portions 15 are provided so as to face each other in the direction in which the opening portion 14B is interposed. Thus, the gap can be positioned from both sides between which the opening portion 14B is interposed.

Further, in the door mirror device 10 of the present embodiment, the wall portion 17A abutting on the rear end 36 of the turn lamp 20 from the vehicle front side is provided on the rear side of the turn lamp 20, and thus, positioning in the vehicle longitudinal direction can be performed with the wall portion 17A.

### Supplementary Explanation of the Embodiment

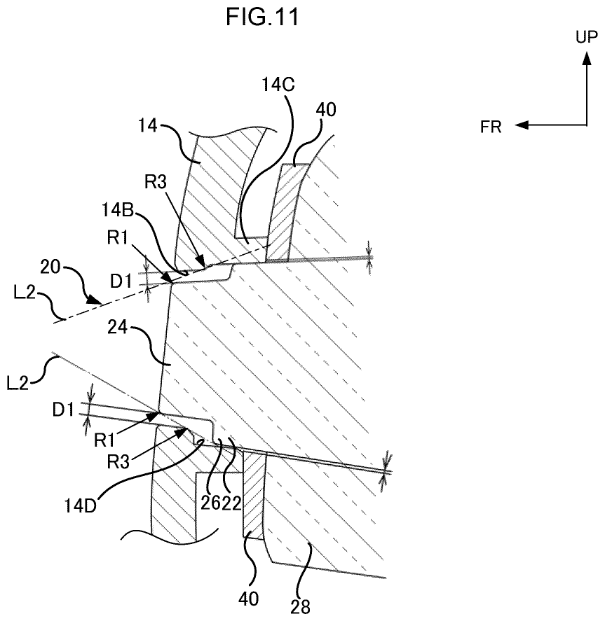

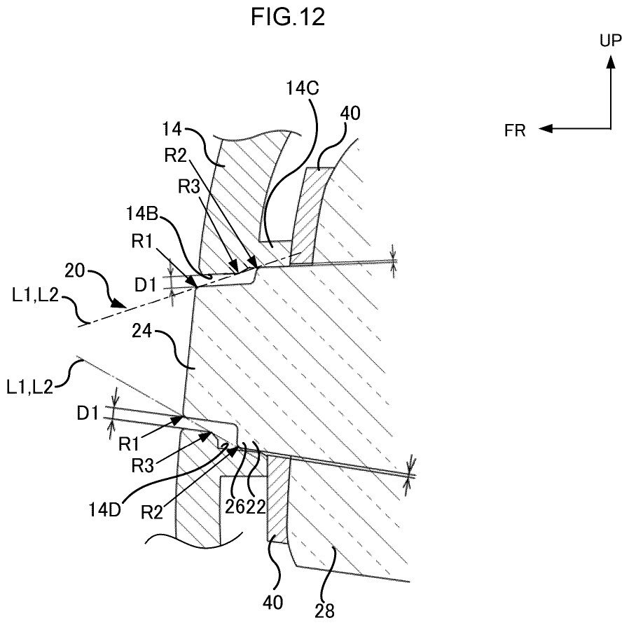

Note that, in the present embodiment described above, the protruding portions 15 are provided at positions shifted from the first straight lines L1 connecting the first corner portions R1 of the distal end of the distal end portion 24 on the vehicle upper side and the vehicle lower side, and the second corner portions R2 of the shoulder portion 26 of the main body portion 22, in a longitudinal sectional view in which the turn lamp 20 is in a mounted state. However, the present disclosure is not limited thereto. FIG. 11 is a cross-sectional view of the relevant portion in a cross section taken along the line III-III in another door mirror device corresponding to FIG. 2, as viewed from the outside in the vehicle width direction. FIG. 12 is a cross-sectional view of the relevant portion in a cross section taken along the line III-III in yet another door mirror device corresponding to FIG. 2, as viewed from the outside in the vehicle width direction.

As illustrated in FIG. 11, the protruding portions 15 are provided at positions shifted from second straight lines L2 connecting the first corner portions R1 of the distal end of the distal end portion 24 on the vehicle upper side and the vehicle lower side, and third corner portions R3 of the inner peripheral rear end of the opening portion 14B, in a longitudinal sectional view in which the turn lamp 20 is in a mounted state.

Alternatively, as illustrated in FIG. 12, the protruding portions 15 are provided at positions shifted from the first straight lines L1 connecting the first corner portions R1 of the distal end of the distal end portion 24 on the vehicle upper side and the vehicle lower side, and the second corner portions R2 of the shoulder portion 26 of the main body portion 22, and from the second straight lines L2 connecting the first corner portions R1 and the third corner portions R3 of the inner peripheral rear end of the opening portion 14B, in a longitudinal sectional view in which the turn lamp 20 is in a mounted state. In FIG. 12, as an example, the first corner portions R1, the second corner portions R2, and the third corner portions R3 are located on the same straight lines.

As the protruding portions 15 are provided at positions deviated from the second straight lines L2 or at a positions deviated from the first straight lines L1 and the second straight lines L2 as described above, the protruding portions 15 can be provided at positions deviated from the line of sight as in the above-described embodiment.

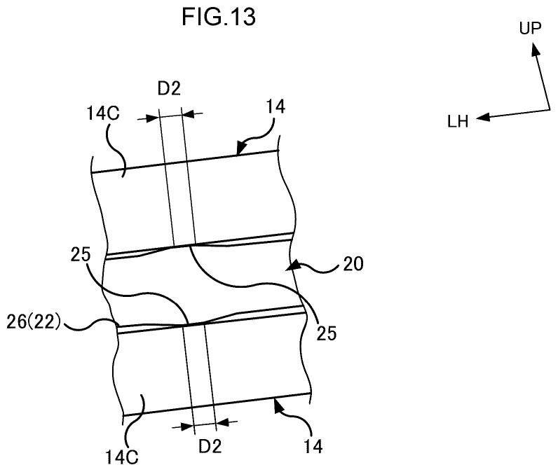

Although the protruding portions 15 are provided on the rear wall portion 14C, the present disclosure is not limited thereto. FIG. 13 is a diagram schematically illustrating another mode of the positioning contact region between the visor cover 14 and the turn lamp 20. As illustrated in FIG. 13, protruding portions 25 may be provided on the shoulder portion 26 of the main body portion 22 of the turn lamp 20, without the protruding portions 15 provided on the rear wall portion 14C of the visor cover 14. The protruding portions 25 are provided on a surface of the shoulder portion 26 on the side facing the rear wall portion 14C. As described above, the protruding portions 25 are provided on the shoulder portion 26, not on the rear wall portion 14C. Accordingly, the protruding portions 25 provided on the shoulder portion 26 abut on the rear wall portion 14C, and thus, positioning can be performed between the turn lamp 20 and the rear wall portion 14C.

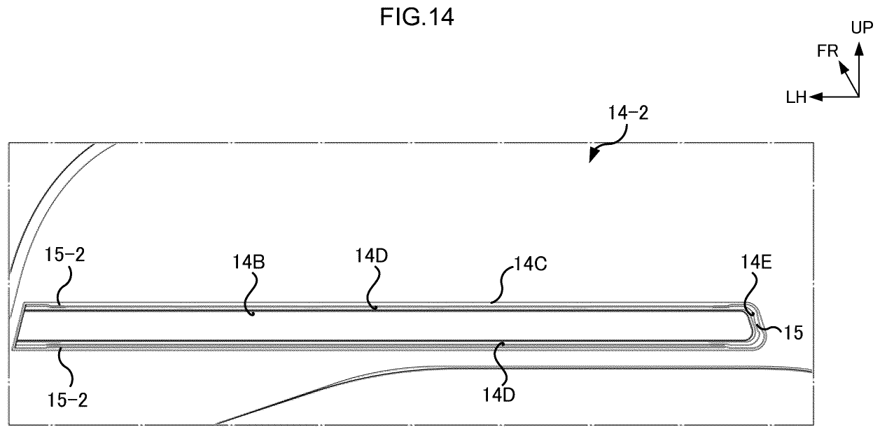

Although the protruding portions 15 are arranged at intervals in the embodiment described above, the present disclosure is not limited thereto, and protruding portions may be arranged in a continuous manner. FIG. 14 is a schematic rear view of another visor cover 14-2 as viewed from the vehicle rear side. As illustrated in FIG. 14, the visor cover 14-2 of the present embodiment does not have plural protruding portions 15 but has one protruding portion 15-2 on each of the surfaces 14D facing each other in the vehicle vertical direction. Specifically, as an example, protruding portions 15-2 are formed by connecting the flat surfaces of the respective protruding portions 15 in the above-described embodiment to form one flat surface.

As described above, in a case where the protruding portions 15-2 are arranged in a continuous manner, the contact areas between the protruding portions 15-2 and the turn lamp 20 can be made larger than those in a case where plural protruding portions 15 is arranged at intervals. Thus, positioning can be performed more firmly.

Further, in the embodiment described above, the door mirror device 10 has been described as an example of a vehicle visual recognition device. However, a vehicle visual recognition device of the present disclosure is not necessarily the door mirror device 10. A vehicle visual recognition device may be adopted in an in-vehicle camera monitor system (a CMS camera) or the like on which, instead of the mirror 18, a camera capable of capturing a subject on the rear side and a monitor that displays a video image captured by the camera are mounted.

Although an example of the present disclosure has been described so far, the present disclosure is not limited to the above, and it is needless to say that various modifications other than the above can be made thereto, without departing from the scope of the disclosure.

What is claimed is:

1. A vehicle visual recognition device comprising:
a cover part having an opening portion;
a lens part having a distal end portion disposed at the opening portion, with a predetermined gap maintained from an inner peripheral surface of the opening portion;
a rear wall portion standing on an outer peripheral side and a back surface side of the opening portion in the cover part; and
a protruding portion that is interposed between the rear wall portion and the lens part, and that has a position of contact with one of the rear wall portion or the lens part on the outer peripheral side of the opening portion.

2. The vehicle visual recognition device according to claim 1, wherein the protruding portion is provided at a position shifted from at least one of a first straight line or a second straight line, the first straight line connecting a first corner portion of an end of the distal end portion of the lens part and a second corner portion of a main body portion provided at the lens part and in contact with the protruding portion, and the second straight line connecting the first corner portion and a third corner portion of an inner peripheral rear end of the opening portion, in a longitudinal sectional view of a mounted state.

3. The vehicle visual recognition device according to claim 2, wherein
a shoulder portion that has a wider portion in a vehicle vertical direction and faces the rear wall portion is formed at the main body portion, and
a sealing member is disposed at the shoulder portion so as to extend from an end surface of the rear wall portion on a side of the lens part.

4. The vehicle visual recognition device according to claim 1, wherein the protruding portion is provided at the rear wall portion.

5. The vehicle visual recognition device according to claim 1, wherein the protruding portion is provided at the lens part.

6. The vehicle visual recognition device according to claim 1, wherein the protruding portion is provided at each of surfaces facing each other in a vehicle vertical direction.

7. The vehicle visual recognition device according to claim 1, wherein the protruding portion is provided at at least one of surfaces facing each other in a vehicle width direction.

8. The vehicle visual recognition device according to claim 1, wherein protruding portions are arranged in a continuous manner or at intervals.

9. The vehicle visual recognition device according to claim 1, comprising a plurality of protruding portions,
wherein the plurality of protruding portions is provided to face each other in a direction in which the opening portion is interposed between the protruding portions.

10. The vehicle visual recognition device according to claim 1, wherein a wall portion abutting on a rear end of the lens part from a vehicle front side is provided on a rear side of the lens part.
